(19) United States
(12) Patent Application Publication
(10) Pub. No.: US 2011/0252799 A1
(43) Pub. Date: Oct. 20, 2011

(54) CONDENSER TUBE HAVING INCREASED HYDROPHOBICITY, PRODUCTION METHOD AND USE THEREOF

(75) Inventors: Anett Berndt, Erlangen (DE); Florian Eder, Erlangen (DE); Sebastian Kamps, Grub am Forst (DE); Heinrich Zeininger, Obermichelbach (DE)

(73) Assignee: SIEMENS AKTIENGESELLSCHAFT, Munich (DE)

(21) Appl. No.: 12/998,956

(22) PCT Filed: Oct. 30, 2009
(86) PCT No.: PCT/EP2009/064349

§ 371 Date: Jun. 20, 2011

(30) Foreign Application Priority Data
Dec. 19, 2008 (DE) 10 2008 064 125.1

(51) Int. Cl. F01K 13/00; B05D 3/12; B05D 3/10; F16L 9/14; B05D 5/00

(52) U.S. Cl. 60/645; 138/146; 427/274; 216/37

(57) ABSTRACT

A condenser tube has a superhydrophobic surface. The superhydrophobic surface is produced on steam condenser tubes to achieve an improved runoff of condensation drops. These condenser tubes may be used in steam power generation. The surface of the condenser tube is textured so that the drops of condensation formed can run off well.

### CROSS REFERENCE TO RELATED APPLICATIONS

This application is based on and hereby claims priority to International Application No. PCT/EP2009/064349 filed on Oct. 30, 2009 and German Application No. 10 2008 064 125.1 filed on Dec. 19, 2008, the contents of which are hereby incorporated by reference.

### BACKGROUND

The invention relates to a condenser tube having a superhydrophobic surface, to a method for producing a superhydrophobic surface of steam condenser tubes to achieve improved runoff of condensation drops, and to the use of condenser tubes.

In the power station-sector a large number of turbines are driven by steam to produce energy. The water used for this has to exhibit a high level of purity in order to avoid calcifications and deposits. Since the steam throughput of a power station turbine is enormous, the water issuing from the turbine must be liquefied by condensation and finally returned to the evaporation process again, so the cycle is closed.

The steam, which is still approximately 50° C., is condensed in condensers through which cooling water flows and which are either constructed from titanium or austenitic steel tubes. These tubes have a poor condensation effect owing to their surface properties. The condensed steam completely wets the condenser tube due to the high surface energy of the metal, so a thin film of water always impedes the exchange of thermal energy during operation (insulation effect) and therefore worsens the condenser efficiency.

A coating agent for producing a hydrophobic surface for condenser tubes is known from application DE 10 2007 015450 with which it is possible to make at least condensation drops from the film of water. Corresponding US 2010/0129645 published on May 27, 2010 is hereby incorporated by reference. One drawback of the known hydrophobic coating, however, is that runoff of the condensation drops is not possible on the tubes.

Coatings are known from other sources in which neither the stability of the coating thereof not the hydrophobicity, which brings about runoff of the drops, is adequate. Furthermore, the coatings are often extremely expensive to produce.

### SUMMARY

One possible object is therefore to overcome at least one drawback of the related art and in particular to allow runoff of the condensation drops.

The inventors propose a condenser tube having a surface wherein a microtexture cooperates with a coating in such a way that drops formed by condensation run off the texture of the condenser tube, as in channels. The inventors also propose a method for the surface treatment of condenser tubes, which involves at least two process steps, wherein firstly the condenser tube is coated with at least one water-repellent, i.e. hydrophobic, coating agent, and secondly at least one texture is produced on the surface of the condenser tube and/or in the coating. Finally the inventors propose the use of condenser tubes with such surfaces in the power station sector.

### DETAILED DESCRIPTION OF THE PREFERRED EMBODIMENT

Reference will now be made in detail to the preferred embodiments of the present invention, examples of which are illustrated in the following description.

The coating of the surface of the condenser tube preferably comprises water-repellent components, for example alkyl groups or fluorinated alkyl groups. By way of example a liquid solvent may also be provided in the hydrophobic coating agent. The coating material is selected, for example, from the group comprising sol gel materials based on silicon oxide sol, fluoropolymers, silicones and/or polyurethane-forming components, wherein, based on the total weight of the coating agent respectively:
the solids content of the sol gel material based on silicon oxide sol is in the range of ≧0.5% by weight to ≦20 & by weight; and/or
the fluoropolymer content is in the range of ≧0.1% by weight to ≦5% by weight; and/or
the silicone solids content is in the range of ≦5% by weight to ≦30% by weight; and/or
the polyurethane-forming components content is in the range of ≧3% by weight to ≧30% by weight.

According to a further embodiment, the hydrophobic coating agent is selected from the group comprising sol gel paints based on silicon oxide, fluoropolymers, silicones and/or paints based on polyurethane.

By way of example the coating has a layer thickness in the range of ≧100 nm to ≦5 μm.

The solvent is preferably a liquid solvent. The term “liquid” denotes that the solvent is liquid in a temperature range from 10° C. to 100° C., for example at room temperature, i.e. in a temperature range from 18° C. to 25° C.

The coating agent, i.e. the coating of the surface, can be applied by all known coating methods, for example by dipping, spraying, spin-coating, deposition, staining and many others. When staining the tube surface with coating agent it is particularly advantageous if the coating is textured at the same time.

Microtexturing is performed by way of example by sputtering processes, by etching processes, wet chemical and/or dry chemical texturing methods or other texturing methods.

Inexpensive texturings such as roller marking, grinding, sandblasting and/or etching are particularly advantageous. An electrochemical treatment such as anodizing or oxalic acid dipping may also be employed.

A further possibility, which is used in particular with geometrically complicated three-dimensional surfaces, is spray coating. For this purpose particles are dispersed in the coating agent or in a separate dispersion and following spraying onto the surface of the coating produce a roughness in that the particles are randomly distributed in the coating. In this case different roughnesses can be produced by varying the particle size and/or combining different particle sizes and by varying the particle concentration. In the case of the particle concentration a saturation effect occurs which does not allow a further increase in concentration.

Methods for texturing the substrate may also be used as an alternative or in addition. By way of example, sandblast or grinding methods can be used to produce a texture on the surface of the substrate, i.e. the condenser tube.

Grinding can be performed, for example, by sandpaper with different surface roughnesses. Contact angles of up to 130° have been achieved in this connection. Furthermore, texturing can take place by way of sandblasting, wherein it has become clear that a fundamental parameter is the type of sand which is being used for sandblasting, in particular in relation to the aspect ratio. Both methods, sandblasting and grinding, produce a roughness on the ductile and metal substrate. The coating agent, which introduces the chemical functionalities into the surface, then forms only a thin film on the substrate surface which has already been textured.

The coating agent is advantageously only applied after texturing of the tube surface, so the texturing is depicted in the coating.

According to a further advantageous embodiment of the method a texturing is produced in the coating. This can take place by way of all common printing and rolling methods.

According to a preferred embodiment the surface texture is introduced into the finished coating by a roller marking method using, for example, a silicone stamp. For this purpose, according to a further advantageous embodiment, silicone stamps can be produced by forming sandpaper with different surface roughnesses using liquid silicone. For this purpose liquid silicone is poured onto sandpaper and after the silicone has hardened it is removed, wherein it exhibits the impression of the sandpaper as a surface texture. By way of imprinting, possibly by a roller, this texture is then impressed into the coating. A roll-to-roll method by way of example can be used in this method to produce a surface texture.

On the other hand the coating can also be textured by etching or by texture-imparting particles. Finally, textures may also be produced in the coating by the incorporation of templates which, for example, are also removed after the texture has been constructed. In the case of the particles, these can be mixed directly with the coating solution and painted on.

Hybrid cross-linked sol gel systems are preferably used as the layer material since these exhibit good adhesion to the substrate and a water-repelling effect that is stable in the long term, in addition to outstanding texturing capacity.

Furthermore, the texture can be produced in the coating by spray coating on a hot substrate. In this case the solvent evaporates immediately after it has impinged on the substrate and, depending on the solvent used, solids concentration employed and substrate temperature, leaves behind a texture with defined statistical roughness. Contact angles of >150° C. have already been achieved in this way when using layer materials containing fluoro alkyl.

According to one embodiment a combination of a coarse and a fine texture may also exist in which a (coarse) texture is firstly produced on a tube surface and then a coating is applied in which a nano(fine) texture is in turn produced. All of the above-described process steps may therefore be combined.

The technical advantages of the hydrophobic, i.e. drop-forming, coating agent can be linked with those of the runoff textures. Therefore great advantages can be achieved in the condensation and runoff behavior of a condenser tube by the proposed coating with a texture.

On the one hand the adhesion of a formed drop is diminished owing to the reduced surface energy of the substrate, so the drop can detach more easily from the tube and drip off. Small drops in particular, whose weight was previously too low to drip off, can also effortlessly detach from the tube.

On the other hand, the coating brings about a marked reduction in the angle of slip to less than 5°, so drops, regardless of the position at which they form on the tube, runoff solely due to the effect of gravity and due to the existing textures, as in channels.

The proposals described herein allow extremely superhydrophobic coatings with which even runoff angles which are not conceivable with anti-adhesion coatings alone are possible, in addition to the film of water on the tube outer wall, mentioned in the introduction, being prevented. By way of example, runoff angles of less than 30° are possible, wherein it should be considered that there is no runoff of small drops of water with uncoated tubes even in the vertical position.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-10. (canceled)

11. A condenser tube comprising:
a tube body; and
a surface coating provided on the tube body, a microtexture cooperating with the surface coating in such a way that drops formed by condensation run off the condenser tube.

12. The condenser tube as claimed in claim 11, wherein the surface coating is water-repellent.

13. The condenser tube as claimed in claim 11, wherein the surface coating contains alkyl groups and/or fluorinated alkyl groups as water-repellent components.

14. The condenser tube as claimed in claim 11, wherein the surface coating agent is formed from a material selected from the group consisting of silicon oxide sol gel paints, fluoropolymers, silicones and polyurethane paints.

15. A method for surface treating a condenser tube, comprising:
applying a surface coating on a surface of a condenser tube body, the surface coating being formed from at least one water-repellent, hydrophobic, coating agent; and
producing a texture on the surface of the condenser tube body.

16. The method as claimed in claim 15, wherein the the texture is produced separately and independently from applying the surface coating.

17. The method as claimed in claim 15, wherein the texture is a microtexture formed by at least one of grinding, sputtering, etching, roller marking, anodizing, oxalic acid dipping and sandblasting.

18. The method as claimed in claim 15, wherein the texture is produced by independently and separately texturing the surface coating and the surface of the condenser tube body.

19. The method as claimed in claim 15, wherein the texture is produced by at least one of a marking method and incorporating particles into the surface coating.

20. The method as claimed in claim 15, wherein the texture is produced before the surface coating is applied.

21. The method as claimed in claim 15, wherein the texture is produced after the surface coating is applied.

22. The method as claimed in claim 15, wherein the texture is produced at the same time as the surface coating is applied.

23. A method for condensing steam in a power station, comprising:
passing a coolant though through condenser tubes comprising:
a tube body; and
a surface coating provided on the tube body, a microtexture cooperating with the surface coating in such a way that drops formed by condensation run off the condenser tube; and
passing post-turbine steam across an outside of the condenser tubes to condense the post-condenser steam.
